(19) United States
(12) Patent Application Publication
(10) Pub. No.: US 2010/0141394 A1
(43) Pub. Date: Jun. 10, 2010

(54) RADIO COMMUNICATION APPARATUS AND METHOD THEREOF

(75) Inventor: Makoto Sugiyama, Shizuoka-ken (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/630,031

(22) Filed: Dec. 3, 2009

(30) Foreign Application Priority Data
Dec. 4, 2008 (JP) 2008-309640

(51) Int. Cl. H04Q 5/22

(52) U.S. Cl. 340/10.4

(57) ABSTRACT

There is provided a radio communication device capable of accurately selecting an object RF-tag to be processed and a non-object RF-tag not to be processed.

An RF-tag inquiry unit inquires for tag identification information to an RF-tag by radio communication. A radio field intensity detecting unit detects a radio field intensity of a response radiowave returned from the RF-tag, and a radio field intensity determining unit determines whether or not this radio field intensity is equal to or greater than a threshold. An execution control unit executes a prescribed process applying to the RF-tag whose radio field intensity is determined to be equal to or greater than the threshold. A first radio field intensity determining unit determines a first radio field intensity using the radio field intensity of the radiowave responded from the RF-tag that has been determined to be an object to which a prescribed process is applied, while a second radio field intensity determining unit determines a second radio field intensity using the radio field intensity of the radiowave responded from the RF-tag that has been determined to be non-object not to be processed. A threshold update unit calculates a new threshold using the first radio field intensity and second radio field intensity.

### CROSS REFERENCE TO RELATED APPLICATION

This application is based upon and claims the benefit of priority from prior Japanese Patent Application No. 2008-309640 filed on Dec. 4, 2008, the contents of which are incorporated herein by reference.

### 1. FIELD OF THE INVENTION

The present invention relates to a radio communication device and a method therefor for determining an RF-tag as an object to be processed or one not to be processed based on a predetermined threshold.

### 2. BACKGROUND OF THE INVENTION

Today, a radio communication device has been developed that wirelessly communicates with an RF-tag attached to an article or the like using a radiowave and performs a prescribed process when reading data contained in the RF-tag and writing to it. To perform such a process, the radio communication device first sends an inquiry radiowave to the RF-tag that resides within the communicable area of the radio communication device, and the RF-tag having received this inquiry radiowave returns a response radiowave. The radio communication device performs a process of writing and other operations communicating with the RF-tag that returned the response radiowave.

JP laid-open application publication No. 2006-338179 discloses an RF-tag label issue device as one using such a radio communication device. This device adds a label supply unit to the aforementioned radio communication device. The label supply unit is a unit that supplies a label sheet in which multiple RF-tag labels are adhered onto a band-like base sheet in line at even intervals. The radio communication device communicates with an RF-tag of this RF-tag label adhered to the label sheet and writes a desired data to this RF-tag.

In the past, if an interval between RF-tag labels adhered to a label sheet varies, it had been difficult to set a radio field intensity so that data writing can be applied only to an RF-tag positioned nearest to an antenna of a relative radio communication device. Therefore, it was concerned that, for example, if an interval between RF-tag labels affixed to a base sheet is set relatively narrow, even an RF-tag adjacent to an object RF-tag to which data is to be desirably written is also detected, and then a writing process is accidentally applied to this RF-tag other than the object RF-tag to be desirably written.

To solve this problem, the applicant of the present invention applied for a patent for a technique of detecting an RF-tag as an object for writing process based on a predetermined threshold of a radio field intensity that has been previously set. In this technique, first, a predetermined threshold is set, and the determination is made in reference to the threshold whether or not an RF-tag responded to an inquiry radiowave is an object RF-tag to which a prescribed process is to be applied. However, even in a radio communication device employing such a technique of selecting an RF-tag in reference to a predetermined threshold, the possibility has arisen that, if external environmental conditions (e.g. temperature, relative humidity or conveyer speed fluctuation) change, the selection of object or non-object RF-tags cannot be accurately performed.

That is, in the cases that an convey error occurring when an RF-tag is carried becomes large or receiver sensitivity to a radiowave being affected by a temperature/humidity change varies on the writing process, a concern arises that there may occur more than one RF-tag responding with a radio field intensity value exceeding a predetermined threshold, and the data writing process is thereby erroneously applied to a non-object RF-tag other than one to be legitimately processed.

### SUMMARY OF THE INVENTION

The present invention has been made in view of the above circumstances.

According to one aspect of the invention, there is provided a radio communication device, comprising:

RF-tag inquiry unit which inquires for tag-identification information to an RF-tag;

radio field intensity detecting unit which detects a radio field intensity of a response radiowave returned from the RF-tag;

radio field intensity determining unit which determines whether or not a radio field intensity is equal to or greater than a threshold;

execution control unit which executes a prescribed process for an RF-tag, a radio field intensity of a response radiowave of which has been determined to be equal to or greater than the threshold by the radio field intensity determining unit;

first radio field intensity determining unit which determines a first radio field intensity using a radio field intensity of a response radiowave returned from an RF-tag that is determined to be an object RF-tag for which the prescribed processing is executed;

second radio field intensity determining unit which determines a second radio field intensity using the radio field intensity of a response radiowave returned from the RF tag that has been determined to be a non-object RF-tag for which the prescribed processing is not executed; and

threshold update unit which calculates a new threshold using the first radio field intensity and the second radio field intensity, and updating a current threshold with the new threshold.

### BRIEF DESCRIPTION OF THE DRAWINGS

These and other objects and advantages of this invention will become apparent and more readily appreciated from the following detailed description of the presently preferred exemplary embodiments of the invention taken in conjunction with the accompanying drawings wherein:

FIG. 1 is a structural view of an RF-tag label used in an embodiment according to the present invention;

FIG. 2 is a sectional view taken on line A-A of the RF-tag label;

FIG. 3 is a structural view of an RF-tag label issue device used in an embodiment according to the present invention;

FIG. 4 is a block diagram showing a structure of an RF-tag reader/writer provided in the RF-tag label issue device in the embodiment according to the present invention;

FIG. 5 is a diagram showing a principal memory area formed in the RF-tag reader/writer in the embodiment according to the present invention;

FIG. 6 is a diagram showing process unit provided in the RF-tag reader/writer in the embodiment according to the present invention;

FIG. 7 is a flowchart illustrating the procedure of a principal control process that is executed by a control section of the RF-tag reader/writer in the embodiment according to the present invention;

FIG. 8 is a flowchart illustrating the procedure of a principal control process that is executed by a control section of the RF-tag reader/writer in the embodiment according to the present invention; and

FIG. 9 is a flowchart illustrating the procedure of a principal control process that is executed by a control section of the RF-tag reader/writer in the embodiment according to the present invention.

### DETAILED DESCRIPTION OF THE INVENTION

An embodiment of the present invention will now be described in more detail with reference to the accompanying drawings. However, the same numerals are applied to the similar elements in the drawings, and therefore, the detailed descriptions thereof are not repeated.

This embodiment is the case in which the invention is applied to an RF-tag reader/writer of an RF-tag label issue device that produces an RF-tag label to be affixed to an article in order to administrate articles. According to this embodiment, RF-tags as an object to be processed and RF-tags as a non-object other than one to be processed can be accurately selected.

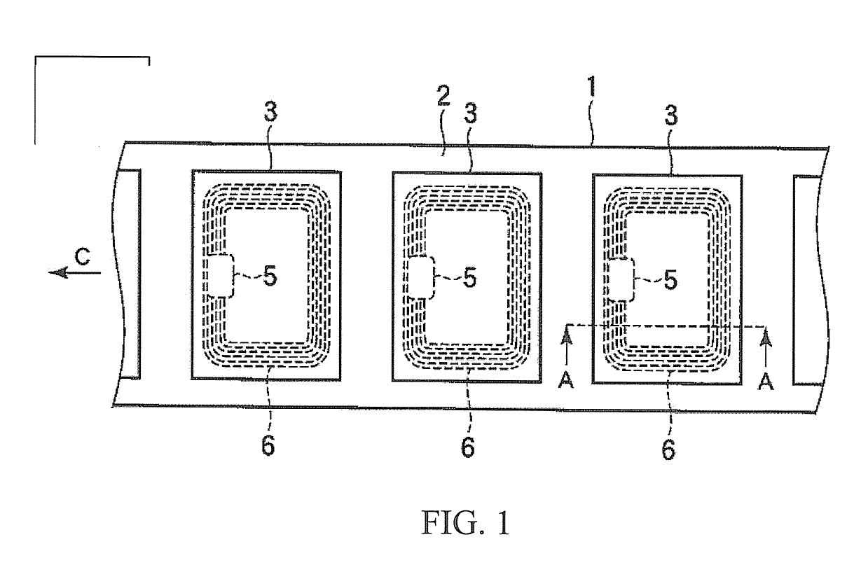

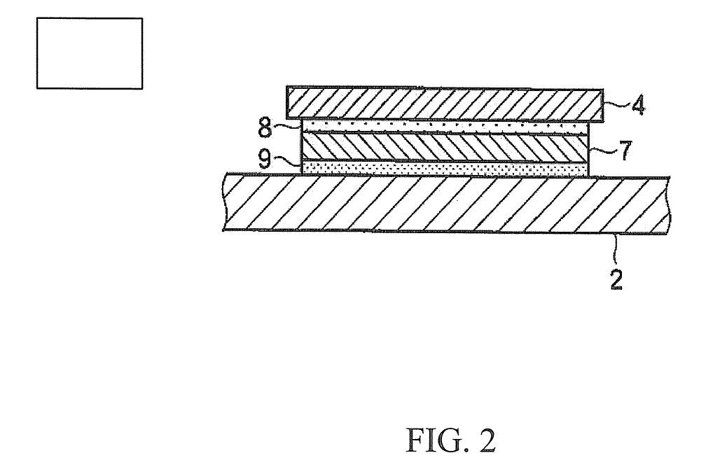

First, an RF-tag label sheet 1 used in this embodiment will be described in conjunction with FIGS. 1 and 2. RF-tag label sheet 1 shown in FIG. 1 is comprised of a band-like base sheet 2 and multiple RF-tag labels 3 separably pasted on the surface of the aforementioned base sheet 2 being arranged in line in a sheet-moving direction C.

FIG. 2 is an enlarged cross-sectional view of RF-tag label 3 taken on dash line A-A of FIG. 1. The RF-tag label will be described below in reference to the same figure. RF-tag label 3, which is separably provided on base sheet 2, is structured such that a label sheet 4 and an RF-tag 7 formed on the back side of label sheet 4 (the adhesive layer side of base sheet 2) incorporating an IC chip 5 and an antenna 6 within a thin film are mounted with an adhesive. In FIG. 2, reference numerals 8, 9 denote an adhesive. The surface of label sheet 4 forms a print surface on which information can be printed, for example, by a thermal printhead.

IC chip 5 incorporated in RF-tag 7 is an electronic circuit component composed of a power generating section, a demodulation section, a modulation section, a memory section, and a control section controlling the preceding sections. The power generating section functions to provide a power to the respective sections of the IC chip by rectifying a radiowave received by the antenna and stabilizing the result. The demodulation section demodulates the radiowave received by the antenna and sends the resulted signal to the control section. The modulation section modulates data sent from the control section into a radiowave and causes the modulated data to be emitted from the antenna. The control section functions to have data demodulated by the demodulation section written in the memory section and to read data from the memory section and send it to the modulation section. The memory section is composed of a setting area retaining data in a non-rewritable state and a user area in which any data can be written. In the setting area, an ID of unique tag identification information is written in advance.

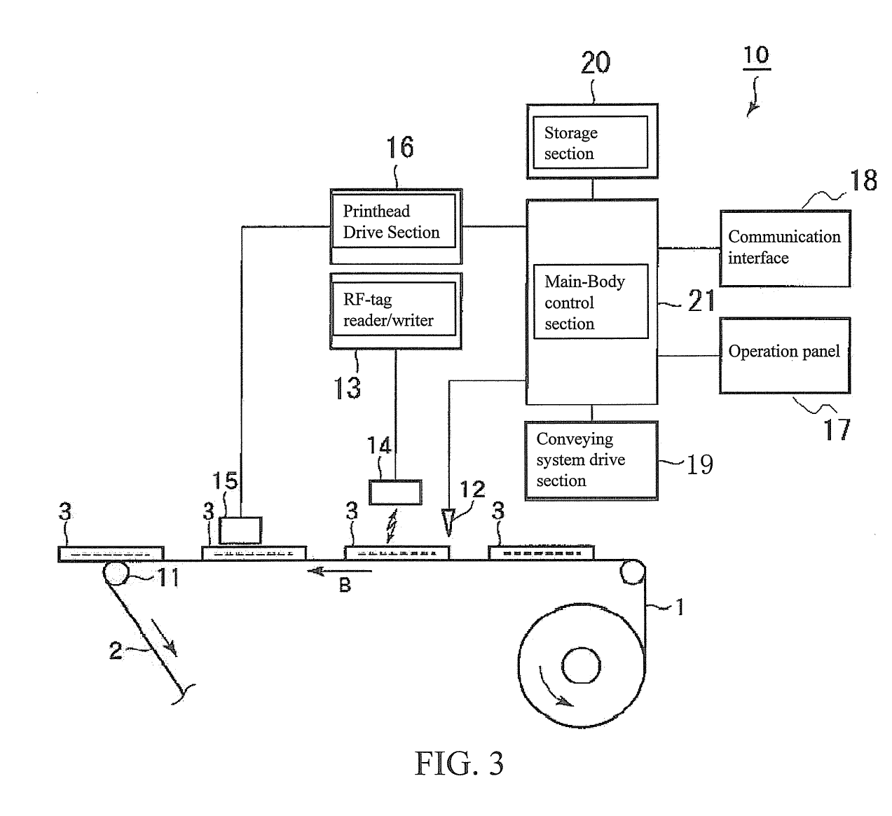

A structure of an RF-tag label issue device to which the present invention is applied will be described below in conjunction with FIG. 3. This RF-tag label issue device 10 writes data to RF-tag 7 provided in the aforementioned RF-tag label 3 using wireless communication and prints necessary information on the surface of a label sheet of RF-tag label 3.

RF-tag label issue device 10 shown in FIG. 3 has a label holder (not shown), to which RF-tag label sheet 1 is set in a state of being wound thereon. This RF-tag label sheet 1 is conveyed along a predetermined sheet-feeding path and led to a peel-off roller 11. When RF-tag label sheet 1 reaches the peel-off roller, RF-tag label 3 pasted on a base sheet is peeled off and only the base sheet is wound off.

A peeled off RF-tag label 3 is discharged as is from an issue port (not shown), while the base sheet turned around the peel-off roller is taken up by a take-up roller (not shown).

Over the sheet-feeding path from the label holder around which RF-tag label sheet 1 is wound in a roll to the peel-off roller, there are provided a label sensor 12, an antenna 14 of RF-tag reader/writer 13, and a printhead 15 sequentially from the upper stream of a sheet-fed direction B of one longitudinal direction of the RF-tag label sheet, i.e. the label holder toward the downstream, i.e. the peel-off roller.

Label sensor 12 detects RF-tag label 3 attached to RF-tag label sheet 1 that is sent out from the label folder. The sensor may be, for example, a type that can optically detect RF-tag label 3, and it detects RF-tag label 3 by the trailing edge in this embodiment.

Antenna 14 radiates a radiowave by the control of RF-tag reader/writer 13 and receives a radiowave radiated from RF-tag 7 of RF-tag label 3. RF-tag reader/writer 13 reads memory data in a non-contact manner from RF-tag 7 of RF-tag label 3 residing within a reachable area of the waveform where a radiowave radiated from antenna 14 can reach, and writes data in the memory section of RF-tag 7.

Print head 15, being driven by a printhead drive section, prints various information on the printable surface of the label sheet that is the surface of RF-tag label 3. Printhead 15 may be of any type that can record by printing, e.g., a thermal printhead.

As shown in FIG. 3, RF-tag label issue device 10 includes an operation panel 17, a communication interface 18, a conveying system drive section 19, a storage section 20, a main-body control section 21, etc., in addition to the aforementioned label sensor 12, RF-tag reader/writer 13, antenna 14, printhead 15, and printhead drive section 16. Operation panel 17 may as well be provided with, for example, various keys for inputting or activating operations or a display section. Communication interface 18, to which a host device such as a personal computer is connected, transmits data. Conveying system drive section 19 controls a sheet feed mechanism for conveying the RF-tag label sheet that is set to the label holder in one longitudinal direction and the opposite direction, and a take-up roller drive mechanism for taking up the base sheet. Label writing data that is input through communication interface 18 and label print data are stored in storage section 20. Main-body control section 21 controls conveying system drive section 19, RF-tag reader/writer 13 and printhead drive section 16 to cause the label writing data to be written in RF-tag 7 and RF-tag label 3 on which label print data is printed to be issued.

Conveying system drive section 19 and sheet feed mechanism being driven by this drive section constitute a tag conveying unit that conveys the RF-tag into the communicable range of the RF-tag reader/writer.

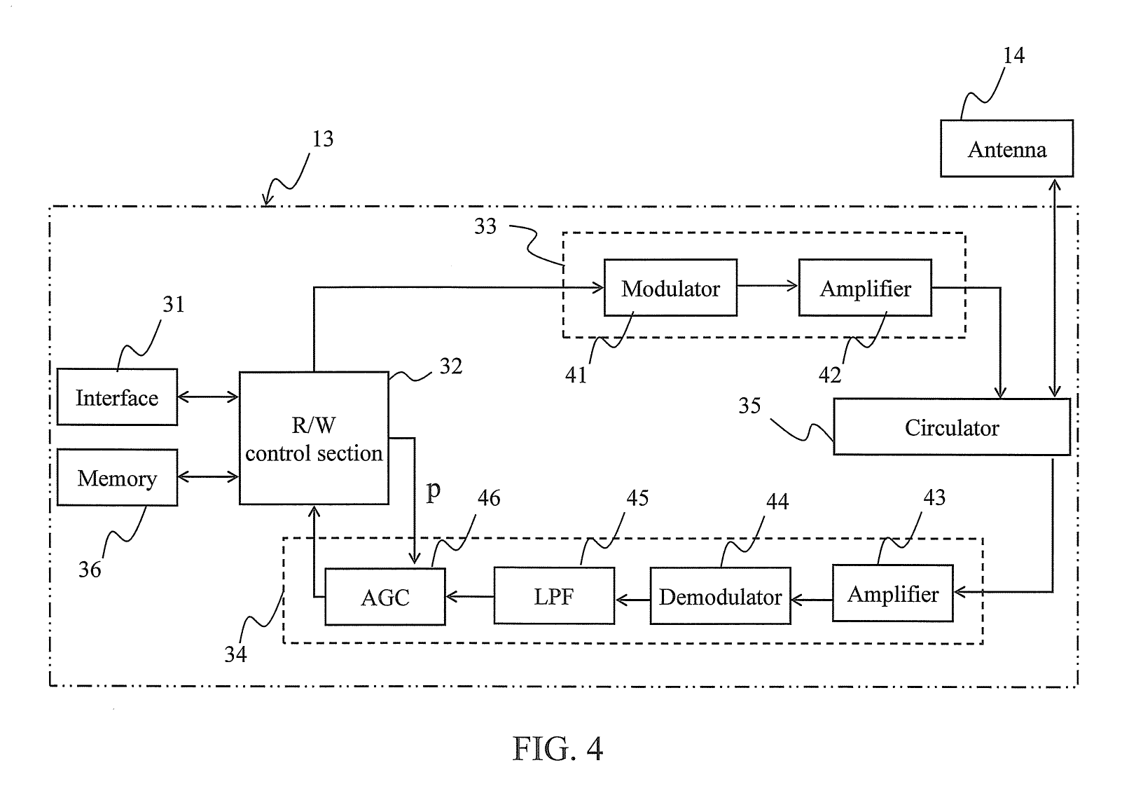

Now, the principal structure of RF-tag reader/writer 13 within RF-tag label issue device 10 will be described in reference to the block diagram of FIG. 4. RF-tag reader/writer 13 is composed of an interface 31 that data-communicates with main-body control section 21, a reader/writer control section 32, a transmission process section 33, a reception process section 34, a circulator 35, memory 36, etc.

Transmission process section 33 is composed of a modulator 41 that modulates a predetermined carrier wave by an analog transmission data signal output from reader/writer control section 32, and an amplifier 42 that amplitudes a signal modulated by modulator 41. The signal amplified by amplifier 42 is supplied to antenna 14 through circulator 35 and radiated as a radiowave from antenna 14.

Circulator 35 functions to output a signal input from the side of transmission process section 33 to antenna 14 and to output a signal input from antenna 14 to the side of reception process section 34. A signal corresponding to a respondence radiowave of RF-tag 7 residing within the relative communicative area is supplied to circulator 35. In this embodiment, a “response radiowave” refers to a radiowave returned from an RF-tag that is responded to an inquiry radiowave from the radio communication device.

Reception process section 34 is composed of an amplifier 43 that amplifies a signal input through circulator 35, a demodulator 44 that demodulates an analog reception data signal removing a predetermined carrier wave component from the signal amplified by amplifier 43, a low-pass filter (LPF) 45 that lets a signal in a predefined low frequency band pass in the reception data signal demodulated by demodulator 44, an automatic gain control circuit (AGC) 46 that controls a gain so that an intensity of the signal passed this LPF 45 becomes an appropriate constant level, etc. The reception data signal thus adjusted by AGC circuit 46 to an appropriate level is supplied to reader/writer control section 32.

Reader/writer control section 32 functions to generate a transmission data signal and supplying the signal to transmission process section 33 according to a command from main-body control section 21 that is connected through interface 31 and to convert the reception data signal supplied from reception process section 34 into data recognizable by main-body control section 21 and supply it to main-body control section 21 through interface 31. Reader/writer control section 32 also functions to generate an AGC parameter p for varying the gain of AGC circuit 46 so that an intensity level of the reception data signal input from AGC circuit 46 becomes an appropriate level and to provide the parameter to AGC circuit 46. AGC parameter p has a greater value as a radio field intensity level becomes greater. In this embodiment, this AGC parameter p is set, for example, to seven steps of 0 to 6.

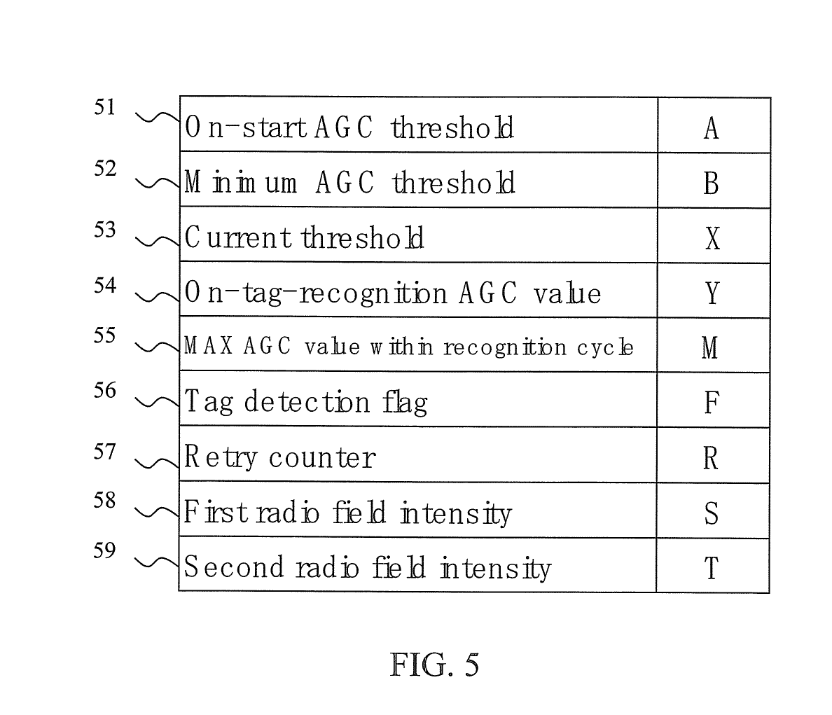

Memory 36 includes a ROM area for read only and a RAM area from or to which data can be freely read or written. The memory in the ROM area stores programs for controlling operation of reader/writer control section 32, etc. In the RAM area, there are formed memory areas 51 to 59, respectively corresponding to an on-start AGC threshold A, a minimum AGC threshold B, a current threshold X, an on-tag-recognition AGC value Y, a max AGC value within recognition cycle M, a tag detection flag F, a retry counter R, a first radio field intensity S, and a second radio field intensity T, shown in FIG. 5. Herein, storage areas 58, 59, 53 in memory 36 for first radio field intensity S, second radio field intensity T, and current threshold X, respectively, correspond to a first radio field intensity storage unit, a second radio field intensity storage unit, and a threshold storage unit, respectively, which will be described later.

Each of the aforementioned on-start AGC threshold A and minimum AGC threshold B is set in advance to an arbitrary value, through main-body control section 21, from a host device connected to main-body control section 21 through communication interface 18.

When a job, for example, to issue RF-tag label 3 is assigned from, e.g., a host device, main-body control section 21 stores label writing data and label print data in storage section 20, and instructs conveying system drive section 19 to start up. Thereby, RF-tag label sheet 1 starts to be conveyed, and main-body control section 21 awaits RF-tag label 3 to be detected. Upon the detection of RF-tag label 3, main-body control section 21 instructs RF-tag reader/writer 13 to write data to a label.

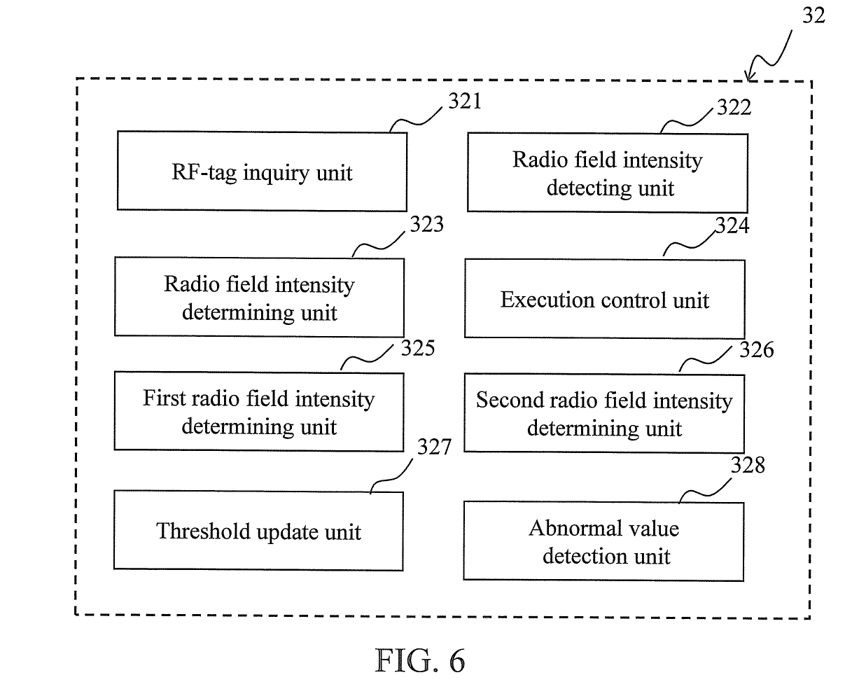

Control section 32 of RF-tag reader/writer 13 is provided with the following unit. FIG. 6 shows specific units provided within reader/writer control section 32. Provided within reader/writer control section 32 are an RF-tag inquiry unit 321 for sending an inquiry command to an RF-tag to inquire for tag ID information, a radio field intensity detecting unit 322 for detecting a radio field intensity level of the response radiowave of the relative RF-tag responded to the inquiry radiowave, a radio field intensity determining unit 323 for determining whether or not an intensity level of the response radiowave is equal to or greater than a predetermined threshold, an execution control unit 324 for performing prespecified processes with respect to an RF-tag whose radio field intensity of a response radiowave has been determined to be equal to or greater than a predetermined threshold, a first radio field intensity determining unit 325 and a second radio field intensity determining unit 326 each for determining a predetermined radio field intensity level to calculate a new threshold, a threshold update unit 327 for calculating a new threshold using the first radio field intensity determined by first radio field intensity determining unit 325 and the second radio field intensity determined by second radio field intensity determining unit 326, and an abnormal value detection unit 328 for determining whether or not a predetermined radio field intensity is an abnormal level. First radio field intensity determining unit 325 determines a first radio field intensity S using the radio field intensity responded from RF-tag 7 that is determined by radio field intensity determining unit 323 to be an object RF-tag to which a predetermined process is applied. The details of how to determine the first radio field intensity will be described later. Second radio field intensity determining unit 326 determines a second radio field intensity T, when one or more of RF-tags 7 exist that are determined to be a non-object RF-tag, using a maximum radio field intensity among those responded from these RF-tags 7. Abnormal value detection unit 328 will be described in detail later.

First radio field intensity S is stored by a first radio field intensity storage unit 58, and second radio field intensity T is stored by a second radio field intensity storage unit 59. A new threshold calculated by threshold update unit 327 is stored by a threshold storage unit. These storage units are provided, for example, in memory 36 within RF-tag reader/writer 13. Abnormal value detection unit 328 detects an abnormal value using minimum AGC threshold B such that, if an object value is found to be lower than minimum AGC threshold B stored in memory area 52, that object value is determined to be an abnormal value. The aforementioned units will be described in detail in reference to flowcharts later.

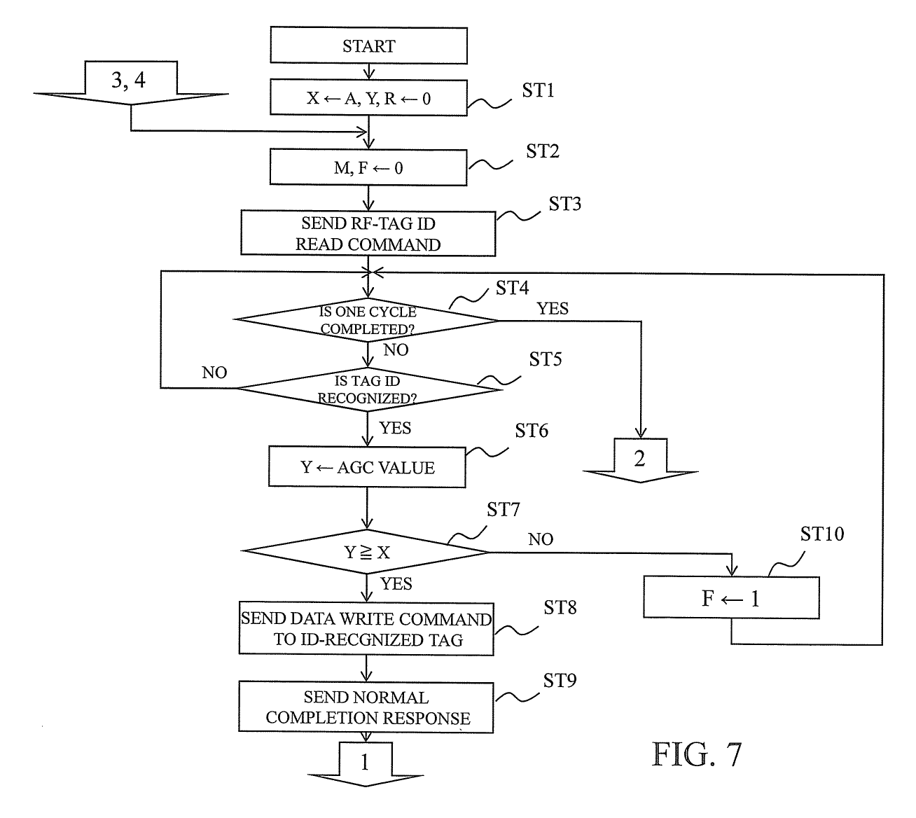

Now, operations performed when reader/writer control section 32 writes data in reference to FIGS. 7, 8, and 9.

First, reader/writer control section 32 reads out on-start AGC threshold A specified in memory area 51. This on-start AGC threshold A corresponds to its initial value, which is first to be set in memory area 53 as a current threshold X. The value of on-tag-recognition AGC value Y in memory 54 is set to zero. Retry counter R in memory area 57 is reset to zero (ST1).

Thereafter, reader/writer control section 32 zeros max AGC value within recognition cycle M in memory area 55. It also zeros tag detection flag F (ST2). After these settings are made, reader/writer control section 32 sends an ID read command for an RF-tag 7 to transmission process section 33 (ST3).

In transmission process section 33, modulator 41 modulates a carrier wave with the ID read command to generate a modulation signal. This modulation signal is then amplified by amplifier 42 and radiated from antenna 14 as an inquiry radiowave to RF-tag 7.

This inquiry radiowave can be received by unspecified multiple RF-tags 7, and any RF-tag 7 having received this inquiry radiowave returns a response radiowave (to reader/writer control section 32). The radiowave returned from RF-tag 7 is received by antenna 14 and sent to reception process section 34. In reception process section 34, the signal derived from this radiowave is amplified by amplifier 43 and demodulated in demodulator 44. This demodulated data signal contains an ID of RF-tag 7. Thereafter, the demodulated data signal is led to LPF 45 wherein a signal component in a predetermined low frequency band is extracted, and this extracted low-frequency signal is supplied to reader/writer control section 32 through AGC circuit 46.

In this case, reader/writer control section 32 generates AGC parameter p for adjusting the gain of AGC circuit 46 so that an intensity of the low-frequency signal supplied by AGC circuit 46 becomes an appropriate level, and supplies this AGC parameter p to AGC circuit 46.

Thereafter, after sending the RF-tag ID read command (ST3), reader/writer control section 32 waits until one write-process cycle passes (ST4). During this waiting time, reader/writer control section 32 determines whether or not the ID of RF-tag 7 has been detected. If an ID of RF-tag 7 is detected from a low-frequency signal supplied through AGC circuit 46 (YES, in ST5) before one write-process cycle passes (NO, in ST4), a current AGC parameter p is detected and stored in memory area 54 as on-tag-recognition AGC value Y (ST6). A series of such operations to detect the field intensity of a radiowave returned from the aforementioned RF-tag are performed in radio field intensity detecting unit 322.

Subsequently, radio field intensity determining unit 323 compares the relative on-tag-recognition AGC value Y within memory area 54 with the current threshold X within memory area 53 (ST7). If the relative on-tag-recognition AGC value Y is found, as the result of the comparison, to be equal to or greater than the current threshold X (YES, in ST7), reader/writer control section 32 recognizes the corresponding RF-tag 7 having the detected ID as an object RF-tag to be processed for writing based on the determination that the radio field intensity at the time of receiving tag ID information of RF-tag 7, i.e. when an ID of the RF-tag 7 is detected, is equal to or greater than a predetermined level, and therefore, the responded RF-tag is positioned nearest to antenna 14 to allow an determination that the relative RF-tag is an object RF-tag to be processed for writing. Thereafter, reader/writer control section 32 reads out label write-data from storage section 20 and outputs a write command for this data to transmission process section 33 (ST8). In transmission process section 33, a carrier wave is modulated by the write command by modulator 41 so that a modulated signal is generated. This modulated signal is then amplified by amplifier 42 and radiated from antenna 14 as a radiowave for write-processing, so that the data is written to the object RF-tag 7 based on the RF-tag ID. A series of the data writing operations to the RF-tag are performed by execution control unit 324.

After the transmission of the write command, RF-tag reader/writer 13 awaits a response of normal completion from the relative RF-tag 7. Having received the normal completion response, RF-tag reader/writer 13 notifies main-body control section 21 of the completion of the data writing process through interface 31 (ST9).

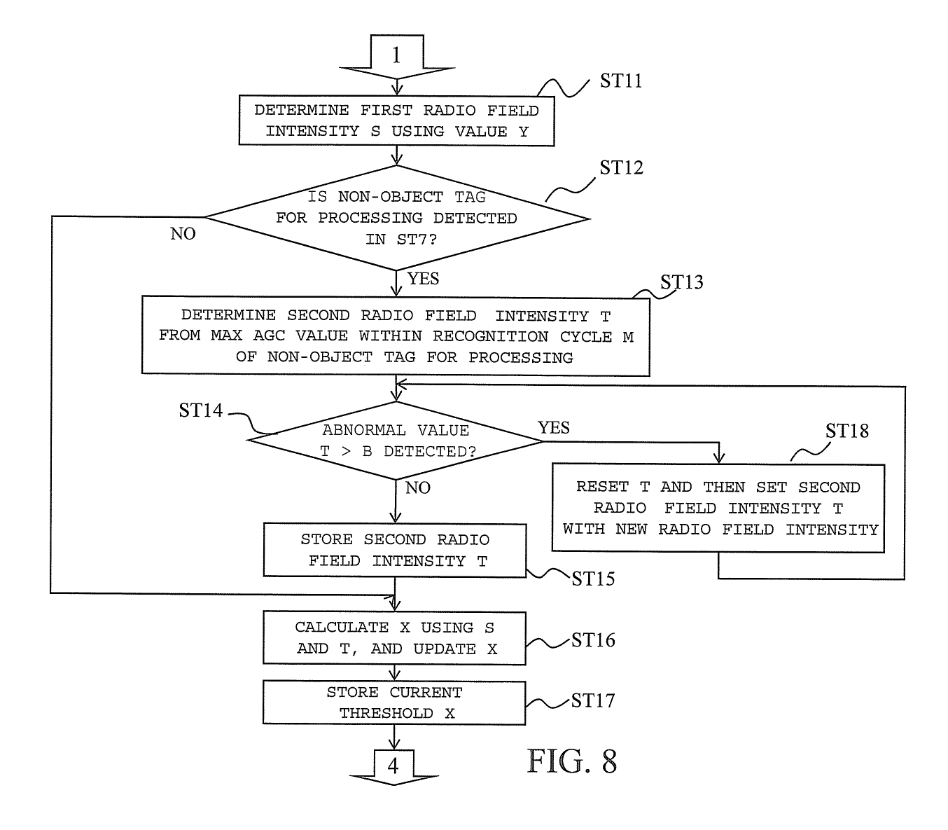

A process following ST9 will be described below in reference to the flowchart in FIG. 8. After received the notification of the completion of data writing process, reader/writer control section 32 determines first radio field intensity S in first radio field intensity determining unit 325 (ST11). First radio field intensity S is a value that is determined using a radio field intensity of a radiowave returned from an RF-tag defined as an object RF-tag to be processed for writing. Herein, first radio field intensity S is acquired using on-tag-recognition AGC value Y at the time of executing the data writing process and a previous threshold stored in a threshold storing unit that will be described later.

In one example of a specific method for determining the radio field intensity S, where first radio field intensity S is determined using on-tag-recognition AGC value Y and a previous threshold stored in the threshold storing unit, first, the total sum of threshold values stored in the threshold storing unit is calculated, and on-tag-recognition AGC value Y at the time of executing the data writing process is added to this total sum, and then an average with respect to the overall previous radio field intensity values is defined as the first radio field intensity S. Alternatively, the first radio field intensity may be obtained from previous threshold values and on-tag-recognition AGC value Y using an arbitrary number of thresholds acquired in several events in the past when the data writing was processed. The method of determining first radio field intensity S need not be restricted to one using threshold values stored in the threshold storing unit. On-tag-recognition AGC value Y acquired when data witting is executed may be used as first radio field intensity S as is. That is, the method of determining a desired radio field intensity may be selected depending on the situation. For example, first radio field intensity S may be defined by multiplying on-tag-recognition AGC value Y by a predetermined coefficient that is acquired from experimental values.

After first radio field intensity S is defined by calculating it in ST 11, if any RF-tag 7 has been detected that is determined in the process of ST 7 that on-tag-recognition AGC value Y was lower than current threshold X, that is, if at least one RF-tag 7 that has been determined to be one other than an object RF-tag to be processed for writing was detected (YES, in ST12), second radio field intensity determining unit 326 determines second radio field intensity T using a radio field intensity of the relative RF-tag 7 that has been determined to be a non-writing object (ST13).

As one specific example of second radio field intensity T, second radio field intensity T is determined using previous second radio field intensity T stored in the second radio field intensity storage determining unit and a max AGC value within recognition cycle M, i.e. a maximum radio field intensity among radio field intensities of radiowave returned from RF-tags that are determined to be a non-writing object. For example, max AGC value within recognition cycle M that is a maximum radio field intensity of an RF-tag among those determined to be one other than an object to be processed is added to the total sum of the previous second radio field intensities stored in the second radio field intensity storage unit. Then, an average of total previous radio field intensities of radiowave returned from RF-tags 7 determined to be a non-writing object is acquired. This average value may be determined to be second radio field intensity T.

Following the determination of second radio field intensity T in ST13, to determine whether or not a received radio field intensity of a radiowave is an abnormal value, this second radio field intensity T is compared with minimum AGC threshold B that is stored in memory area 52 by abnormal value detection unit 328 (ST14). If second radio field intensity T is equal to or greater than minimum AGC threshold B (YES, in ST14), abnormal value detection unit 328 determines this value to be a normal value, and stores it as a then second radio field intensity T in the second radio field intensity storage unit. On the other hand, if this second radio field intensity T is smaller than the minimum AGC threshold B (NO, in ST14), this value is determined to be an abnormal value. The second radio field intensity T determined in ST 13 (ST18) is then reset, and a minimum radio field intensity among radio field intensities stored in the second radio field intensity storage unit is then set as a new second radio field intensity T. The flow returns to ST14. Alternatively, the minimum AGC threshold B may be set as the second radio field intensity T before the flow returning to ST14.

After the second radio field intensity is stored in the second radio field intensity storage unit in ST15, threshold update unit 327 calculates a new threshold using first radio field intensity S and second radio field intensity T. Another method of acquiring a new threshold is, for example, to calculate and set an average of first radio field intensity S and second radio field intensity T as a new threshold. After the new threshold is determined, current threshold X in memory area 53 is updated with the new one (ST16). The updated threshold is then stored in the threshold storage unit (ST17). Thereafter, the flow returns to ST2 to continue to execute the operations following ST2.

If no RF-tags determined to be a non-write object have been detected in ST12 (NO, in ST12), the flow proceeds to ST 16. Herein, second radio field intensity T may use, for example, a previous second radio field intensity T stored as the second radio field intensity in storage area 59. Alternatively, a certain value of radio field intensity to be used when no RF-tags determined to be a non-write object have been detected is set in advance, and this value may be used as a new second radio field intensity T.

When, as the result of comparison of on-tag-recognition AGC value Y and current threshold X in ST 7 of FIG. 7, it was found that on-tag-recognition AGC value Y is smaller than current threshold X (NO, in ST7), the tag detection flag is set to “1” (ST10), and the recognition of the RF-tag in the current write-process cycle is memorized. If the tag detection flag is already set to “1,” this process in ST10 is skipped. Thereafter, the flow returns to the operation of ST4, wherein reader/writer control section 32 determines completion of one write-process cycle (ST4).

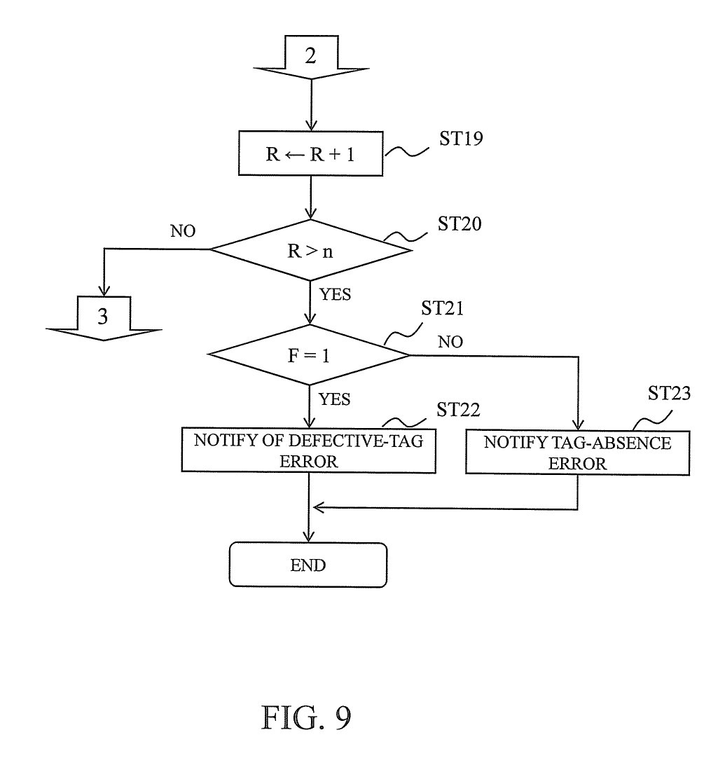

If, the write-process cycle has passed without having detected an ID of RF-tag 7 on the condition that on-tag-recognition AGC value Y is equal to or greater than current threshold X (YES, in ST4), the flow proceeds to ST19 of FIG. 9.

As the operation of ST19, a retry counter R is incremented by one. Then, a determination is made as to whether the value of retry counter R has exceeded a predetermined number n (n is a natural number of more than one) (ST20). If the value of retry counter R has not exceeded a predetermined number n (NO, in ST20), reader/writer control section 32 returns to the operation of ST2. That is, max AGC value within recognition cycle M is zeroed. Tag detection flag is also reset to zero. Thereafter, the RF-tag ID read command is output to transmission process section 33 again.

That is, if the write-process cycle has passed without having detected an ID of RF-tag 7, the ID inquiry is repeated. When, as the result, an ID of RF-tag 7 is first detected on the condition that on-tag-recognition AGC value Y is equal to or greater than current threshold X, the process of data writing is immediately executed with respect to that RF-tag, and the control for the current process is terminated.

On the other hand, if the value of retry counter R has exceeded the retry number n on the condition that on-tag-recognition AGC value Y is equal to or greater than current threshold X (YES, in ST 20), reader/writer control section 32 checks tag detection flag in ST 21. When tag detection flag F is set to “1” (YES, in ST21), since it unit that the ID was detected but the level of its radio field intensity was not sufficiently high, reader/writer control section 32 notifies main-body control section 21 of a defective-tag error through interface section 31 in ST 22. Then, reader/writer control section 32 terminates the control for the current process.

On the contrary, if tag detection flag F is not set to “1” (NO, in ST 21), since it unit that none of IDs of RF-tag 7 has been detected, reader/writer control section 32 notifies main-body control section 21 of the abnormal termination of a tag-absence error through interface section 31 in ST 23. Then, reader/writer control section 32 terminates the control for the current process.

According to the embodiment of the present invention, when the write-process is executed to RF-tag 7, threshold update unit 327 calculates a new threshold and updates the previous threshold. This feature enables selection of an RF-tag using an appropriate threshold according to environmental condition during the writing process, thus improving the accuracy in the write-process with respect to RF-tags. For example, in use of the radio communication device in a low temperature, radiowave reception sensitivity of the radio communication device is upgraded so that radio field intensity of a radiowave returned from an RF-tag tends to be detected generally higher than in normal temperature. Even in this case, because the selection of RF-tags is continuously performed using an appropriate threshold that suites to each of the states in the writing process, a misguided data writing process to an RF-tag of a non-writing object that likely occurs due to variation of a radiowave reception sensitivity of the radio communication device during the write-process can be prevented. Moreover, even in such cases that an object RF tag to be processed is not positioned at a predetermined position where the writing process takes place due to variation of a label conveying speed or performances of RF tags vary, occurrence of more than one RF-tag that responds with a radio field intensity exceeding a predetermined threshold can be prevented as much as possible. Therefore, object RF-tags to be processed and non-object tags not to be processed can be accurately discriminated.

Moreover, providing the threshold storage unit, the first radio field intensity storage unit, and the second radio field intensity storage unit enables the setting of a threshold using previous thresholds, a radio field intensity acquired when the write-process is executed, and a radio field intensity acquired when a determination is made for one other than an object RF-tag to be processed for writing, respectively. This brings an effect that a new threshold can be calculated using an arbitrary previous threshold that the operator desires, first radiowave-intensity, and second radio field intensity, so that, by using a threshold more suitable to various writing environments, an accurate operation can be achieved.

By configuring first radio field intensity determining unit 325 so as to determine a radio field intensity using a radio field intensity from an RF-tag determined to be an object RF-tag to which a predetermined process is applied and previous thresholds, a new threshold can be determined including previous thresholds. Thus, the invention has an effect that accurate selections of RF-tags 7 can be performed reflecting thresholds used during previous selection processes for RF-tags. Furthermore, by configuring second radio field intensity determining unit 326 so as to determine a radio field intensity using a radio field intensity of a response radiowave from an RF-tag other than an object RF-tag to which a predetermined process is to be applied and previous second radio field intensities stored in the second radio field intensity storage unit, a new threshold can be determined reflecting a radio field intensity exhibited when that RF-tag is determined to be other than one to which a predetermined process is to be applied.

Still furthermore, by configuring first radio field intensity determining unit 325 to determine the first radio field intensity using a radio field intensity from an RF-tag determined to be an object RF-tag to which a predetermined process is applied and a previous first radio field intensity, the first radio field intensity can be determined using a radio field intensity responded from an RF-tag when that RF-tag is determined to be an object RF-tag to which a predetermined process is applied. Since a threshold can be thus determined reflecting a radio field intensity exhibited when that RF-tag is determined to be one to which a predetermined process is to be applied, accurate selection of RF-tags can be achieved. In addition, by acquiring a new threshold by an average between the first radio field intensity and the second radio field intensity, the invention brings another effect that a new threshold can be acquired by a simple calculation method.

Moreover, a new threshold reflecting previous thresholds and previous second radio field intensities can be acquired by firstly acquiring the total sum of previous thresholds stored in the threshold storage unit and then calculating an average of radio field intensities wherein a radio field intensity of a response radiowave from RF-tags 7 determined to be ones to be processed is added to the total sum, and secondly acquiring the total sum of the second radio field intensities stored in the second threshold storage unit and then calculating an average of radio field intensities wherein a maximum radio field intensity among response radiowave from RF-tags 7 determined to be one other than an object RF-tag to be processed is added to the total sum, so that a new threshold is calculated using these radio field intensities. Thus, the accuracy of the RF-tag tag selection is upgraded, and the selection for RF-tags determined as an object to be processed and those out of the object RF-tags can be performed without being affected by fluctuation of reception sensitivity due to variation of external environmental conditions such as temperature and humidity.

Still furthermore, by providing abnormal value detection unit 328, even when a radio field intensity responded from RF-tag 7 that is determined to be one other than an object RF-tag to be processed is an abnormal value lower than the preset minimum AGC threshold, a process is performed not to use this radio field intensity value as determined as an abnormal value. That is, such an abnormal value is prevented from being included in candidates for a new threshold in the relative calculation, and therefore, desirable RF-tags can be selected by using more appropriate thresholds.

By providing the tag conveyer, RF-tag labels each with an RF-tag attached thereto can be sequentially carried into a predetermined wireless communication area. By performing the data writing process to RF-tag 7 that is first responded to the inquiry radiowave, an accurate writing process can be performed.

The embodiment described above is only an example, and the invention need not necessarily be restricted to the form of updating a threshold. That is, the threshold updating need not be made every time when the writing process is performed. An embodiment may be such that the selection for the RF-tags determined as an object to be processed and non-object tags not to be processed is performed as may be required according to a fixed threshold that has been set in advance.

Needless to say, the determination of a radio field intensity by first radio field intensity determining unit 325, second radio field intensity determining unit 326, and threshold update unit 327 may be implemented in various ways without being restricted to the way as described in the above embodiment.

Above embodiment was described taking a case in which the radio field intensity was detected using an AGC parameter. However, any information other than the AGC parameter may be used to detect a radio field intensity.

Various inventions can be formed by appropriately combining several components disclosed in the embodiments. For example, some of the components disclosed in the embodiments may be removed, or some components in other embodiment may be combined.

Numerous modifications and variations of the present invention are possible in light of the above teachings. It is therefore to be understood that, within the scope of the appended claims, the present invention can be practiced in a manner other than as specifically described therein.

What is claimed is:

1. A radio communication device, comprising:
RF-tag inquiry unit which inquires for tag-identification information to an RF-tag;
radio field intensity detecting unit which detects a radio field intensity of a response radiowave returned from the RF-tag;
radio field intensity determining unit which determines whether or not a radio field intensity is equal to or greater than a threshold;
execution control unit which executes a prescribed process for an RF-tag, a radio field intensity of a response radiowave of which has been determined to be equal to or greater than the threshold by the radio field intensity determining unit;
first radio field intensity determining unit which determines a first radio field intensity using a radio field intensity of a response radiowave returned from an RF-tag that is determined to be an object RF-tag for which the prescribed processing is executed;
second radio field intensity determining unit which determines a second radio field intensity using the radio field intensity of a response radiowave returned from the RF tag that has been determined to be a non-object RF-tag for which the prescribed processing is not executed; and
threshold update unit which calculates a new threshold using the first radio field intensity and the second radio field intensity, and updating a current threshold with the new threshold.

2. The radio communication device according to claim 1, further comprising:
threshold storage unit which stores the threshold;
first radio field intensity storage unit which stores the first radio field intensity determined by the first radio field intensity determining unit; and
second radio field intensity storage unit which stores the second radio field intensity determined by the second radio field intensity determining unit.

3. The radio communication device according to claim 2, wherein the first radio field intensity determining unit determines a first radio field intensity using the threshold stored in the threshold storage unit and the radio field intensity of a response radiowave returned from the RF tag determined to be an object RF-tag for which the prescribed processing is executed, and wherein the second radio field intensity determining unit determines a second radio field intensity using the second radio field intensity stored in the second radio field intensity storage unit and a radio field intensity of a response radiowave returned from the RF tag that has been determined to be a non-object RF-tag for which the prescribed processing is not executed.

4. The radio communication device according to claim 2, wherein the first radio field intensity determining unit determines a new first radio field intensity using the first radio field intensity stored in the first radio field intensity storage unit and a radio field intensity of a response radiowave returned from the RF tag determined to be an object RF-tag for which the prescribed processing is executed, and wherein the second radio field intensity determining unit determines a new second radio field intensity using the second radio field intensity stored in the second radio field intensity storage unit and the radio field intensity of a response radiowave from the RF tag that has been determined to be a non-object RF-tag for which the prescribed processing is not executed.

5. The radio communication device according to claim 1, further comprising abnormal value determining unit which determines whether or not the radio field intensity of a response radiowave from the RF tag that has been determined to be a non-object RF-tag for which the prescribed processing is not executed is an abnormal value.

6. The radio communication device according to claim 1, wherein the threshold update unit calculates an average between the first radio field intensity and the second radio field intensity, and updates a current threshold with the average as a new threshold.

7. The radio communication device according to claim 2, wherein the first radio field intensity determined by the first radio field intensity determining unit is an average of a radio field intensity acquired from the sum of the radio field intensity of a response radiowave from the RF tag determined to be an object RF-tag for which the prescribed processing is executed and a total sum of thresholds stored in the threshold storage unit, and wherein the second radio field intensity determined by the second radio field intensity determining unit is an average of a radio field intensity acquired from the sum of a maximum radio field intensity among radio field intensities of response radiowave returned from the RF tags that have been determined to be a non-object RF-tag for which the prescribed processing is not executed and a total sum of the second radio field intensities stored in the second radio field intensity storage unit.

8. The radio communication device according to claim 1, further comprising tag conveyer which conveys an RF-tag into a predefined wireless communication area, wherein the execution control unit executes a process of data writing to an RF-tag, a radio field intensity of a response radiowave of which is first determined to be equal to or greater than a threshold by the radio field intensity determining unit among RF-tags conveyed into the wireless communication area.

9. A radio communication method, comprising the steps of:
inquiring for tag identification information to an RF-tag;
detecting a radio field intensity of a response radiowave returned from the RF-tag;
determining whether or not the radio field intensity is equal to or greater than a specified threshold;
executing a prescribed processing for an RF-tag, a radio field intensity of a response radiowave of which has been determined to be equal to or greater than the specified threshold;
determining a first radio field intensity using the radio field intensity of a response radiowave from an RF-tag that has been determined to be an object RF-tag for which the prescribed processing is executed;
determining a second radio field intensity using the radio field intensity of a response radiowave from an RF tag that has been determined to be a non-object RF-tag for which the prescribed processing is not executed; and
calculating a new threshold using the first radio field intensity and the second radio field intensity, and updating a current threshold with the new threshold.
